(19) United States
(12) Patent Application Publication
(10) Pub. No.: US 2008/0149570 A1
(43) Pub. Date: Jun. 26, 2008

(54) METHOD OF CLEANING AND MAINTAINING A MEMBRANE USED WITH AN AQUEOUS STREAM

(76) Inventors: E. H. Kelle Zeiher, Naperville, IL (US); Amit Gupta, Aurora, IL (US)

Correspondence Address: William J. Maheras;Patent and Licensing Department, Nalco Company, 1601 West Diehl Road, Naperville, IL, 60563-1198, US

(21) Appl. No.: 11/613,305

(22) Filed: Dec. 20, 2006

(51) Int. Cl. C02F 1/72; C02F 1/76

(52) U.S. Cl. 210/763

(57) ABSTRACT

This invention is a method for cleaning and maintaining a membrane filtration element/system used in a continuous feed stream wherein an oxidizing agent that does not cause membrane damage is used as a cleaning agent. The cleaning agent used to maintain and clean the membrane is a biocide that is preferably an oxy-chloro species and most preferably a stable chlorous acid.

### COPYRIGHT NOTICE

A portion of the disclosure of this patent document contains or may contain copyright protected material. The copyright owner has no objection to the photocopy reproduction by anyone of the patent document or the patent disclosure in exactly the form it appears in the Patent and Trademark Office patent file or records, but otherwise reserves all copyright rights whatsoever.

### TECHNICAL FIELD

This invention relates to a method for the maintenance and cleaning of membrane filtration elements used for purification and filtration in a continuous flow aqueous stream system. This invention relates to a method of cleaning said membrane filtration elements in an off-line mode or without the need to close the system down while also not risking the quality or integrity of the membrane during the cleaning process.

### BACKGROUND OF THE INVENTION

Membrane separation, which uses a selective membrane, is an increasingly common addition to the industrial separation technology for processing of liquid streams, such as water purification. In membrane separation, a small amount of constituents of the influent typically pass through the membrane as a result of a driving force(s) in the feed stream, to form the permeate stream (on the other side of the membrane), thus leaving behind elevated amounts of the original constituents in a stream known as the concentrate or reject stream.

Membrane separation methods commonly used for water purification or other liquid processing include microfiltration (MF), ultrafiltration (UF), nanofiltration (NF), reverse osmosis (RO), electrodialysis, electrodeionization, pervaporation, membrane extraction, membrane distillation, membrane stripping, membrane aeration, and other processes.

Pressure-driven membrane filtration uses pressure as the driving force and is commonly known as membrane filtration. Pressure-driven membrane filtration includes microfiltration, ultrafiltration, nanofiltration and reverse osmosis. In contrast to pressure driven membrane filtration an electrical driving force is used in electrodialysis and electrodeionization.

Historically, membrane separation processes or systems were not considered cost effective for water treatment due to the adverse impacts that membrane scaling, membrane fouling, membrane degradation and the like had on the efficiency of removing solutes from aqueous water streams. However, advancements in technology have now made membrane separation a more commercially viable technology for treating aqueous feed streams suitable for use in industrial and domestic processes.

During membrane separation, deposits of scale and foulants (biological or colloidal) on the membrane can adversely impact the performance of the membrane. For example, foulants and scales can decrease the permeate flow through the membrane for a given driving force, lower the permeate quality (purity), quantity, increase energy consumed to maintain a given permeate flow, or the like. This can necessitate a cleaning process for the membrane separation system in order to remove the scalants, foulants, and the like from the membrane separation system. Thus, the performance of the membrane system in use can be recovered. Recovery can be partial [some gains in quantity (flux) and quality (salt rejection)] or full (performance restored to start up conditions).

Biofouling is a particularly difficult type of fouling to control, prevent or clean. Biofouling is ubiquitous and consists of fouling by microbial foulants and the substances that they produce. This includes the “extra-cellular polysaccharides” known as the EPS or slime that often contains colonies of organisms. Biofouling, whether from living or dead organisms, or the extra cellular products they produce, can clog flow channels in the membrane. Further, biofouling can attract other types of foulants such as colloidal foulants or scale. It can also contribute to fouling by scaling and other partially soluble salts. It does so by altering the flow dynamics within the membrane. When flow does not have sufficient turbulence, the natural concentration gradient that exists within a membrane can create problems. More severe (“thicker”) gradients can be formed. Since reverse osmosis membranes allow a percentage of the salt at the membrane barrier to pass through, the concentration gradient needs to be minimized. If it is not, the membrane surface sees a higher concentration of salts than in the bulk solution. A percentage of this higher concentration of salts passes through the membrane, resulting in a lower permeate quality (higher conductivity) than would be experienced in the absence of the “thick” concentration gradient.

Membrane cleaning processes usually consist of removing the membrane system from service, rinsing the membrane system (membranes, housings and associated piping) with high quality (preferably permeate quality) water, preparing a cleaning agent by adding the cleaner to a specified volume of permeate quality water, heating the cleaning agent, and circulating the cleaning agent at low pressure through the membranes. In this regard, the cleaning agent acts to remove sealants, foulants, or the like that have deposited on surfaces of the membrane system, including the membrane itself. A further step consists of adding to the cleaning procedure a product to kill and/or remove biofoulants. The cleaning process may further consist of alternately circulating the cleaning agent through the membrane system and soaking the membrane system in the cleaning agent. During the process the system may be rinsed and fresh cleaning agent applied as needed. Finally the system is rinsed with permeate quality water and either subjected to a second cleaning or placed back in service. An example of a typical membrane cleaning process includes adding a suitable cleaning agent and circulating the cleaning agent within the membrane separation system. After the membrane system has been washed with the cleaning agent the system is flushed or rinsed to remove the cleaning agent and other impurities that may remain in the system.

The second or third step in a series of cleaning agents is often a cleaning specific for biofouling removal, as discussed above.

The cleaning process involves considerable down time, subsequent loss of productivity, and consequential membrane deterioration. It is generally desired to maintain the membrane system so that the time between cleanings in maximized.

Biofouling control in water systems is most economically and easily achieved by the use of oxidizing biocides such as hypochlorite, however, it is known in the industry that such oxidizing compounds cause membrane damage and increased salt passage through the membranes. Best practices include using non-oxidizing biocides to kill the organisms and surfactants and/or detergents to remove both the organisms and the biofilms. Both of these are primarily used off line.

### SUMMARY

The current invention is a form of stabilized solution containing oxy-chloro species which have been demonstrated to be (a) more compatible with membranes than traditional oxidants, (b) does not pass through the membrane, (c) can be applied off-line or on-line, (d) extends the time between membrane cleanings, and (e) is effective at removing both the biological organisms and the EPS that they generate, thus keeping flow channels clear for longer.

### DETAILED DESCRIPTION

The present invention relates to a method for cleaning and maintaining a membrane used in a continuous feed stream wherein an oxidizing agent that does not cause membrane damage is used as a cleaning agent and is combined with the continuous feed stream consistently, intermittently or as a full batch when the continuous stream feed is interrupted.

The cleaning agent is further a biocide and preferably an oxy-chloro species. The most preferred oxy-chloro species is chlorous acid. The chlorous acid is continuously produced in a stable formulation in quantity and used. The chlorous acid is fed into the continuous feed line through a dispensing station.

When the cleaning agent is passed into the continuous stream at intermittent times, the intervals are pre-determined and the amount of cleaning agent used is pre-determined. The rate and timing of the addition of the cleaning agent is controlled by an external monitoring source.

### EXAMPLES

The foregoing may be better understood by reference to the following examples, which are intended to illustrate methods for carrying out the invention and are not intended to limit the scope of the invention.

### Example 1

A membrane system was fed with water containing biologically active material, nutrient salts and approximately 2000 ppm of NaCl. The membrane was treated daily with either (a) deionized water (b) chlorine dioxide or (c) stabilized chlorous acid. Treatments lasted for 30 minutes, followed by a 5 minute rinse. During this time the permeate flows were monitored. A loss of permeate flow (flux) is a sign of membrane fouling. A 10% loss indicates that the membrane should be taken off line and cleaned. An increase in flux typically signifies membrane damage. The changes in flux with exposure to the various treatments are shown in the table below.

Flux Changes with and without Treatment**

| | | | | | “Stabilized |
|---|---|---|---|---|---|
| Days of | Control | | ClO₂ | | Chlorous Acid” |
| Operation | #1 | #2 | ~1.8 ppm | ~0.8 ppm | ~21 ppm |
| 0 | 0 | 0 | 0 | 0 | 0 |
| 1 | −2 | −21 | 10 | −3 | −4 |
| 2 | −7 | −30 | −9 | 0 | −9 |
| 3 | −13 | −34 | 13 | −7 | −10 |
| 4 | −20 | −36 | 7 | −9 | −5 |
| 5 | −30 | −43 | 4 | | −6 |
| 6 | −29 | −43 | 17 | −19 | −3 |
| 7 | | −51 | | −26 | −8 |
| | Unacceptable | Unacceptable | Flux gain indicates | Unacceptable | No significant flux |
| | flux loss | flux loss | possible membrane | flux loss after | loss; performance |
| | | | damage | 5 days | enhanced |

**Positive numbers represent a flux increase; negative represent a loss of flux
**Acceptable flux change is no more than −10%

### It is clear from the table that the stabilized chlorous acid delays the onset of significant fouling and flux loss.

### Example 2

A membrane system was fed with water containing, nutrient salts and approximately 2000 ppm of NaCl. Biologically active material was neither introduced nor excluded. The membrane was treated continuously with either (a) deionized water (b) chlorine dioxide or (c) stabilized chlorous acid. During this time the permeate flows and salt rejection were monitored. A loss of permeate flow (flux) is a sign of membrane fouling. A 10% loss indicates that the membrane should be taken off line and cleaned. An increase in flux typically signifies membrane damage.

Flux (gpm) with and without Treatment**

| Hours of | | | |
|---|---|---|---|
| Operation | Control | ClO₂ | “Stabilized Chlorous Acid” |
| 0 | 367 | 367 | 367 |
| 192 | 315 | 431 | 315 |
| 262 | 285 | 311 | 311 |
| | 10% flux loss reached | Flux increase may | Performance maintained at acceptable level |
| | after 192 hours and | signify membrane | for 36% longer than the control. |
| | continues to decline | damage | 10% flux loss reached after 192 hours but |
| | rapidly, signifying the | | remains stable and does not decline rapidly |
| | need to clean | | until after 262 hours |

It should be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

We claim:

1. A method for cleaning and maintaining a membrane used in a continuous feed stream wherein an oxidizing agent that does not cause membrane damage is used as a cleaning agent and is combined with the continuous feed stream consistently.

2. The method of claim 1 wherein the cleaning agent is a biocide.

3. The method of claim 1 wherein the cleaning agent is an oxy-chloro species.

4. The method of claim 1 wherein the cleaning agent is stable chlorous acid.

5. The method of claim 4 where in the chlorous acid is produced in quantity and stored prior to use.

6. The method of claim 5 where in the chlorous acid is introduced into the feed line through a remote dispensing station.

7. A method for cleaning and maintaining a membrane used in a continuous feed stream wherein an oxidizing agent that does not cause membrane failure is used as a cleaning agent and is combined with the feed stream at intermittent intervals for a pre-determined duration.

8. The method of claim 7 wherein the addition of the cleaning agent is controlled by an external monitoring source.

9. The method of claim 7 wherein the cleaning agent is a biocide.

10. The method of claim 7 wherein the cleaning agent is an oxy-chloro species.

11. The method of claim 7 wherein the cleaning agent is stable chlorous acid.

12. The method of claim 11 where in the chlorous acid is produced in quantity and stored prior to use.

13. The method of claim 12 where in the chlorous acid is introduced into the feed line through a remote dispensing station.

14. The method of claim 1 where in a cleaner that does not affect the integrity of the membrane is added in with the cleaning agent to further assist in the cleaning and maintaining of the membrane.

15. The method of claim 14 wherein the cleaner is a surfactant.

16. A method for cleaning and maintaining a membrane used in a continuous feed stream wherein an oxidizing agent that does not cause membrane failure is used as a cleaning agent and is placed in the continuous feed system as a batch while the continuous feed stream is interrupted.

17. The method of claim 16 wherein the cleaning agent is a biocide.

18. The method of claim 17 wherein the cleaning agent is an oxy-chloro species.

19. The method of claim 17 wherein the cleaning agent is stable chlorous acid.

20. The method of claim 19 where in the chlorous acid is produced in quantity and stored prior to use.

21. The method of claim 20 where in the chlorous acid is introduced into the feed line through a remote dispensing station.
